(19) United States
(12) Patent Application Publication
(10) Pub. No.: US 2024/0218091 A1
(43) Pub. Date: Jul. 4, 2024

(54) PRE-POLYMERIZED CATALYST COMPONENTS FOR THE POLYMERIZATION OF OLEFINS

(71) Applicant: Basell Poliolefine Italia S.r.l., Milano (IT)

(72) Inventors: Dario Liguori, Ferrara (IT); Tiziano Dall'occo, Ferrara (IT); Giampiero Morini, Ferrara (IT); Gianni Vitale, Ferrara (IT)

(73) Assignee: Basell Poliolefine Italia S.r.l., Milano (IT)

(21) Appl. No.: 18/285,835

(22) PCT Filed: Mar. 24, 2022
(86) PCT No.: PCT/EP2022/057811

§ 371 Date: Oct. 5, 2023

(30) Foreign Application Priority Data
Apr. 6, 2021 (EP) 21166913.0

(51) Int. Cl. C08F 10/02

(52) U.S. Cl. CPC C08F 10/02

(57) ABSTRACT

A pre-polymerized catalyst component for the polymerization of olefins made from or containing (a) a solid catalyst component made from or containing Ti, Mg, and a halogen and optionally, a bidentate electron donor compound (BE) in an amount such that the molar ratio (BE)/Ti ranges from 0 to 0.3, and (b) an ethylene (co)polymer in an amount ranging from 0.1 g up to less than 30 g per g of the solid catalyst component, and having an intrinsic viscosity, measured in tetraline at 135° C., of at least 3.0 dL/g, wherein the pre-polymerized catalyst component has a porosity measured by mercury method in the range 0.1 to 1 cm³/g.

### FIELD OF THE INVENTION

In general, the present disclosure relates to the field of chemistry. More specifically, the present disclosure relates to polymer chemistry. In particular, the present disclosure relates to catalyst components for the preparation of ethylene (co)polymers.

### BACKGROUND OF THE INVENTION

In some instances, catalyst components for the polymerization of olefins, including ethylene, are obtained by supporting a titanium compound chosen from the group consisting of titanium halides, titanium alkoxides, and titanium halo alcoholates, on a magnesium dihalide. In some instances, the catalyst components are used with an aluminum alkyl compound in the polymerization of ethylene. In some instances, the catalyst components, and the catalysts obtained therefrom, are used in plants for the homopolymerization or copolymerization of ethylene, operating in liquid phase (slurry or bulk) or gas-phase. However, in some instances, the reactivity of the ethylene harms the kinetics of the polymerization reaction, thereby placing the catalyst under tension during the initial stage of polymerization and uncontrollably breaking the catalyst. A further consequence is the formation of fine particles of polymer, thereby leading to low bulk density of the polymer and process difficulties.

In some instances, the catalyst is pre-polymerized under controlled conditions. In some instances, the tendency of the resulting catalysts to break under polymerization conditions is decreased.

However and in some instances, the preparation of the pre-polymerized catalyst system has very low productivity.

### SUMMARY OF THE INVENTION

In a general embodiment, the present disclosure provides a pre-polymerized catalyst component for the polymerization of olefins, made from or containing (a) a solid catalyst component made from or containing Ti, Mg, and a halogen and optionally, a bidentate electron donor compound (BE) in an amount such that the molar ratio (BE)/Ti ranges from 0 to 0.3, and (b) an ethylene (co)polymer in an amount ranging from 0.1 g up to less than 30 g per g of the solid catalyst component, and having an intrinsic viscosity, measured in tetraline at 135° C., of at least 3.0 dL/g, wherein the pre-polymerized catalyst component has a porosity measured by mercury method in the range 0.1 to 1 cm³/g.

### DETAILED DESCRIPTION OF THE INVENTION

The features and the constituents of the pre-polymerized catalyst component are not inextricably linked to each other. Accordingly, a level of a first feature does not necessarily involve the same level of the remaining features of the same or different constituents. As such, the present disclosure supports any combination of pre-polymerized catalyst constituents and features.

As used herein, the term “non-stereospecific solid catalyst component” refers to a solid catalyst component as such or in a pre-polymerized form, which yields a propylene homopolymer, having an insoluble fraction in xylene at 25° C. lower than 70%, alternatively lower than 65%, alternatively lower than 60%, under the polymerization conditions described in the experimental section. As used herein, the term “stereospecific catalyst” refers to a solid catalyst component, which yields a propylene homopolymer, having an insoluble fraction in xylene at 25° ° C. higher than 70%, under the same polymerization conditions.

In some embodiments, the intrinsic viscosity is equal to or higher than 4.0 dl/g, alternatively ranging from 4.5 to 15 dl/g, alternatively in the range 5-12 dl/g.

As used herein, the term “ethylene (co)polymer” refers to an ethylene homopolymer or an ethylene copolymer. In some embodiments, the ethylene (co)polymer is an ethylene homopolymer or an ethylene copolymer containing less than 5% by mol, alternatively less than 3% by mol, of an alpha-olefin having the formula CH₂—CHR¹, wherein R¹ is a C₁-C₆ linear alkyl group. In some embodiments, the alpha-olefin is selected from the group consisting of propylene butene-1, hexene-1, and octene-1. In some embodiments, the ethylene (co)polymer is an ethylene homopolymer.

In some embodiments, the amount of ethylene (co)polymer is less than 10 g, alternatively less than 5 g, per g of solid catalyst component. In some embodiments, the amount is from 0.5 to 2.5 g per g of solid catalyst component.

In some embodiments, the pre-polymerized catalyst component has a mercury porosity due to pores radius up to 1 μm ranging from 0.20 to 0.90 cm³/g, alternatively from 0.30 to 0.80 cm³/g.

In some embodiments, the average pore radius associated to the porosity ranges from 100 to 300 nm, alternatively from 150 to 280 nm.

In some embodiments, the pre-polymerized catalyst component has a bulk density ranging from 0.34 to 0.50 g/cm³, alternatively from 0.35 to 0.50 g/cm³, alternatively from 0.36 to 0.50 g/cm³.

In some embodiments, the solid catalyst component is non-stereospecific. In some embodiments, the solid catalyst component is made from or containing a titanium compound and a magnesium dihalide. In some embodiments, the magnesium halides, alternatively MgCl₂, in active form used as a support for Ziegler-Natta catalysts, are as described in U.S. Pat. Nos. 4,298,718 and 4,495,338. In some embodiments, the magnesium dihalides in active form used as support or co-support in components of catalysts for the polymerization of olefins have X-ray spectra, wherein the most intense diffraction line in the spectrum of the non-active halide is diminished in intensity and broadened to form a halo.

In some embodiments, the titanium compounds have the formula Ti(OR^{II})_{4-y} X_{y}, wherein R^{II} is a C₁-C₂₀ hydrocarbon group, X is halogen, and y is a number between 1 and 4. In some embodiments, the titanium compounds are selected from the group consisting of TiCl₄, Ti-tetraalcoholates, and Ti-chloroalcoholates having the formula Ti(OR^{III})ₐCl₄₋ₐ where “a” is a number between 1 and 4, and R^{III} is a C₁-C₈ alkyl or aryl group. In some embodiments, R^{III} is selected from the group consisting of ethyl, propyl, n-butyl, isobutyl, 2-ethylhexyl, n-octyl, and phenyl.

In some embodiments, the titanium compound is pre-formed. In some embodiments, the titanium compound is produced in-situ by the reaction of a titanium tetrahalide, alternatively TiCl₄, with alcohols R^{II}OH or with titanium alkoxides having the formula Ti(OR^{II})₄ where R^{II} is a C₁-C₂₀ hydrocarbon group.

In some embodiments, more than 70%, alternatively more than 90%, alternatively 100%, of the titanium atoms of the solid catalyst component before pre-polymerization are in the 4⁺ valence state.

In some embodiments, the non-stereospecific solid catalyst components were made from or containing an electron donor compound (internal donor), selected from the group consisting of ethers, esters, amines, and ketones. In some embodiments, the electron donor compound does not have stereo regulating ability or is present in an amount such that the electron donor does not provide stereo regulating ability to the catalyst. In some embodiments, the electron donors not having stereo regulating ability are present in an amount such that the electron donor's molar ratio to Ti is lower than 10, alternatively lower than 7, alternatively lower than 5. In some embodiments, bidentate electron donors (BE) are absent or present in amount such that the (BE)/Ti ratio is from 0 to lower than 0.2, alternatively from 0 to lower than 0.1. In some embodiments, bidentate electron donors (BE) are absent.

In some embodiments, the bidentate electron donors are selected from the group consisting of esters of aliphatic or aromatic dicarboxylic acids, esters of monocarboxylic acids with aliphatic or aromatic diols, and 1,3-diethers. In some embodiments, the bidentate electron donors are esters of aliphatic or aromatic dicarboxylic acids selected from the group consisting of phthalates, succinates, and glutarates.

In some embodiments, electron donors not having stereo regulating ability are monodentate (MD). In some embodiments, the monodentate electron donors are selected from the group consisting of esters of aliphatic or aromatic carboxylic acids and cyclic alkyl ethers. In some embodiments, the esters of aliphatic or aromatic carboxylic acids are ethylacetate or benzoates. In some embodiments, the cyclic alkyl ether is tetrahydrofuran. In some embodiments, the monodentate donors are present in an amount such that the (MD):Ti ratio ranges from 0.1:1 to 25:1, alternatively from 0.5:1 to 20:1, alternatively from 1:1 to 15:1.

In some embodiments, the solid catalyst component (a) has a porosity PF determined with the mercury method ranging from 0.2 to 0.80 cm³/g, alternatively from 0.3 to 0.70 cm³/g, alternatively in the range 0.35-0.60 cm³/g.

In some embodiments, the surface area measured by the BET method is lower than 80, alternatively between 10 and 70 m2/g. In some embodiments, the porosity measured by the BET method is between 0.10 and 0.50, alternatively from 0.10 to 0.40 cm³/g.

In some embodiments, the catalyst components are prepared by a method including step (a) reacting a compound MgCl₂·mR^{III}OH, wherein 0.3≤m≤ 1.7 and R^{III} is an alkyl, cycloalkyl or aryl radical having 1-12 carbon atoms, with the titanium compound having the formula Ti(OR^{II})_{4-y} X_{y}, wherein R^{II} is a C₁-C₂₀ hydrocarbon group, X is halogen, and y is a number between 1 and 4.

In some embodiments, MgCl₂·mR^{III}OH represents a precursor of Mg dihalide. In some embodiments, MgCl₂·mR^{III}OH compounds are obtained by mixing alcohol and magnesium chloride in the presence of an inert hydrocarbon immiscible with the adduct, operating under stirring conditions at the melting temperature of the adduct (100-130° C.), thereby preparing an emulsion. Then, the emulsion is quickly quenched, thereby causing the solidification of the adduct in form of spherical particles. In some embodiments, the procedure for the preparation of the spherical adducts is as disclosed in U.S. Pat. Nos. 4,469,648 and 4,399,054, and Patent Cooperation Treaty Publication No. WO98/44009. In some embodiments, the method for the spherulization is the spray cooling method described in U.S. Pat. Nos. 5,100,849 and 4,829,034. In some embodiments, the adducts are obtained by directly using the amount of alcohol. In some embodiments, adducts with increased porosity are obtained by first preparing adducts with more than 1.7 moles of alcohol per mole of MgCl₂ and then subjecting the adducts to a thermal or chemical dealcoholation process. In some embodiments, the thermal dealcoholation process is carried out in nitrogen flow at temperatures between 50 and 150° C. until the alcohol content is reduced to a value ranging from 0.3 to 1.7. In some embodiments, the process is as described in European Patent No. EP 395083.

In some embodiments, the dealcoholated adducts have a porosity (measured by mercury method) due to pores with radius up to 0.1 μm ranging from 0.15 to 2.5 cm³/g, alternatively from 0.25 to 1.5 cm³/g.

In some embodiments and in the reaction of step (a), the molar ratio Ti/Mg is stoichiometric or higher; alternatively higher than 3. In some embodiments, an excess of titanium compound is used. In some embodiments, the titanium compounds are titanium tetrahalides, alternatively TiCl₄. In some embodiments, the reaction with the Ti compound is carried out by suspending the adduct in cold TiCl₄; the mixture is heated up to 80-140° C. and kept at this temperature for 0.5-8, alternatively from 0.5 to 3 hours. In some embodiments, the temperature of the cold TiCl₄ is 0° C. In some embodiments, the excess of titanium compound is separated at high temperatures by filtration or sedimentation and siphoning. In some embodiments, step (a) is repeated twice or more. In some embodiments, the catalysts contain an electron donor compound, which is added with the titanium compound in the reaction system for reaction with the MgCl₂·mR^{III}OH adduct. In some embodiments, the electron donor compound is first contacted with the adduct alone. Then, the product is reacted with the titanium compound. In some embodiments, the electron donor compound is added separately in a further step after the completion of the reaction between the adduct and the titanium compound.

In some embodiments, the pre-polymerized catalyst component is obtained by pre-polymerizing (a) a solid catalyst component made from or containing Ti, Mg, and a halogen and optionally, a bidentate electron donor compound (BE) in an amount such that the molar ratio (BE)/Ti ranges from 0 to 0.3, with (b) ethylene and optionally an alpha olefin CH₂═CHR¹ such that the amount of ethylene (co)polymer generated ranges from 0.1 up to 50 g per g of the solid catalyst component, wherein the pre-polymerization is carried out at a temperature ranging from 25 to 100° C. in the presence of (B) an Al alkyl compound such that the molar ratio Al/Ti is lower than 0.5.

In some embodiments, the pre-polymerization is carried out in the further presence of an external electron donor compound (C) in such an amount to have a molar ratio (B)/(C) lower than 50, alternatively from 0.1 to 20, alternatively from 0.5 to 10, alternatively from 0.5 to 8.

In some embodiments, the Al-alkyl compound is selected from the group consisting of trialkyl aluminum compounds. In some embodiments, the trialkyl aluminum compounds are selected from the group consisting of triethylaluminum, triisobutylaluminum, tri-n-butylaluminum, tri-n-hexylaluminum, and tri-n-octylaluminum. In some embodiments, the trialkyl aluminum compound is tri-n-octylaluminum. In some embodiments, the Al-alkyl compound is a mixture of trialkyl aluminum compounds with alkylaluminum halides, alkylaluminum hydrides, or alkylaluminum sesquichlorides. In some embodiments, the alkylaluminum sesquichlorides are selected from the group consisting of AlEt₂Cl and Al₂Et₃Cl₃.

In some embodiments, the pre-polymerization uses an alkyl-Al compound in an amount to provide an Al/Ti molar ratio lower than 0.4, alternatively lower than 0.3, alternatively lower than 0.2.

In some embodiments, the external electron donor compound is selected from the group consisting of alcohols, glycols, esters, ketones, amines, amides, nitriles, alkoxysilanes, and ethers.

In some embodiments, the alkoxysilanes have the formula (R⁷)ₐ(R⁸)_{b}Si(OR₉)_{c}, where a and b are integers from 0 to 2, c is an integer from 1 to 4, and the sum (a+b+c) is 4; R⁷, R⁸, and R⁹ are radicals with 1-18 carbon atoms optionally containing heteroatoms. In some embodiments, a is 1, b is 1, c is 2, at least one of R₇ and R₈ is selected from branched alkyl, cycloalkyl or aryl groups with 3-10 carbon atoms optionally containing heteroatoms, and R⁹ is a C₁-C₁₀ alkyl group. In some embodiments, R₉ is a methyl group. In some embodiments, the silicon compounds are selected from the group consisting of methylcyclohexyldimethoxysilane (C donor), diphenyldimethoxysilane, methyl-t-butyldimethoxysilane, dicyclopentyldimethoxysilane (D donor), diisopropyldimethoxysilane, (2-ethylpiperidinyl)t-butyldimethoxysilane, (2-ethylpiperidinyl) thexyldimethoxysilane, (3,3,3-trifluoro-n-propyl)(2-ethylpiperidinyl)dimethoxysilane, methyl(3,3,3-trifluoro-n-propyl)dimethoxysilane, and N,N-diethylaminotriethoxysilane. In some embodiments, a is 0, c is 3, R₈ is a branched alkyl or cycloalkyl group, optionally containing heteroatoms, and R₉ is methyl. In some embodiments, the silicon compounds are selected from the group consisting of cyclohexyltrimethoxysilane, t-butyltrimethoxysilane, and thexyltrimethoxysilane. In some embodiments, the silicon compounds are aminosilanes as disclosed in European Patent Application No. EP-A-1538167.

In some embodiments, the ethers are selected from the group consisting of alkoxybenzenes as described in Patent Cooperation Treaty Publication No. WO2011/015553, cyclic alkyl ethers, and 1,3-diethers. In some embodiments, the cyclic alkyl ether is tetrahydrofuran. In some embodiments, the 1,3-diethers are as described in European Patent Nos. EP362705 and EP728769.

In some embodiments, the esters are selected from the group consisting of monoesters of aromatic carboxylic acids and monoesters of aliphatic carboxylic acids. In some embodiments, the monoesters of aromatic carboxylic acids are benzoates, alternatively the C₁-C₁₀ alkyl esters of benzoic acids. In some embodiments, the monoesters of aliphatic carboxylic acids are C₁-C₈ alkyl esters of aliphatic mono carboxylic acids, alternatively ethylacetate.

In some embodiments, the esters are selected from the group consisting of C₁-C₁₀ alkyl esters of aromatic dicarboxylic acids and C₁-C₁₀ alkyl esters of aliphatic dicarboxylic acids. In some embodiments, the esters are selected from the group consisting of phthalates, malonates, succinates and glutarates. In some embodiments, the esters are selected from the group consisting of diesters of diols. In some embodiments, the diesters of diols are as described in U.S. Pat. No. 7,388,061 and Patent Cooperation Treaty Publication No. WO2010/078494.

In some embodiments, the esters are selected from the group consisting of ethylacetate, di-isobutyl phthalate, p-ethoxy-ethylbenzoate, and diethyl 2,3-diisopropylsuccinate

In some embodiments, the alcohols have the formula R³OH, wherein R³ is a C₁-C₂₀ hydrocarbon group. In some embodiments, R³ is a C₁-C₁₀ alkyl group. In some embodiments, the alcohols are selected from the group consisting of methanol, ethanol, isopropanol, and butanol.

In some embodiments, the pre-polymerization is carried out in liquid phase, (slurry or solution) or in gas-phase at temperatures ranging from 25 to 100° C., alternatively ranging from 30 to 80° C., alternatively ranging from 30 to 70° C. In some embodiments, the pre-polymerization is carried out in a liquid diluent, alternatively liquid hydrocarbons. In some embodiments, the liquid hydrocarbons are selected from the group consisting of pentane, hexane, and heptane. In some embodiments, the ethylene feeding is higher than 0.08 gC2⁻/gcat/h, alternatively ranging from 0.16 gC2⁻/gcat/h to 1.6 gC2⁻/gcat/h.

In some embodiments, the particles of the pre-polymerized catalyst component have substantially spherical morphology and an average diameter between 15 and 200 μm, alternatively from 20 to 150 μm, alternatively from 25 to 100 μm. As used herein, the term “substantially spherical morphology” refers to particles having the ratio between the greater axis and the smaller axis equal to or lower than 1.5, alternatively lower than 1.3.

In some embodiments, the pre-polymerized catalyst is used as obtained in the polymerization or subjected to further treatments. In some embodiments, the solid catalyst component used in the pre-polymerization does not contain an internal electron donor, and a prepolymer treatment supports an electron donor on the prepolymer. In some embodiments, the electron donor is an internal donor and carried out by contacting the prepolymer and the electron donor in a liquid hydrocarbon medium. In some embodiments, the liquid hydrocarbon medium is removed by drying. In some embodiments, the prepolymer is contacted with a gaseous stream containing the electron donor compound. In some embodiments, a non-pre-polymerized catalyst component is contacted with a gaseous stream containing the electron donor compound as described in Patent Cooperation Treaty Application No. PCT/EP2020/081034.

In some embodiments, the pre-polymerized catalyst remains non stereospecific also after the contacting with the electron donor compounds. In some embodiments, the electron donor is selected from the group consisting of esters of aliphatic or aromatic carboxylic acids and cyclic alkyl ethers. In some embodiments, the ester is ethylacetate. In some embodiments, the cyclic alkyl ether is tetrahydrofuran. In some embodiments, the electron donor is a mixture as described in Patent Cooperation Treaty Publication No. WO2018/114453.

In some embodiments, treatments are selected from the group consisting of reaction with titanium compounds containing at least one Ti-halogen bond, treatments with halogenating agents, and treatments with aluminum alkyls.

In some embodiments and in gas-phase polymerization, the fraction of polymer particles having particle size below 500 μm, alternatively below 300 μm, is reduced. In some embodiments, the fraction of polymer particles having particle size below 500 μm is reduced by more than 25% wt. In some embodiments, the fraction of polymer particles below 300 μm is reduced by more than 50%, alternatively more than 70%.

In some embodiments, the ethylene homopolymerization or copolymerization processes are carried out in the presence of a catalyst made from or containing (A) the pre-polymerized catalyst component and (B) the Al-alkyl compound. In some embodiments and in the main polymerization process, the amount of Al is higher than that used in the pre-polymerization step. In some embodiments, the Al-alkyl compound is used in an amount such that the Al/Ti ratio is higher than 1, alternatively between 20 and 800. In some embodiments, (C) the external electron donor compound is used in the ethylene polymerization step.

In some embodiments, the catalysts are used in slurry polymerization, using as diluent an inert hydrocarbon solvent, or bulk polymerization, using the liquid monomer as a reaction medium. In some embodiments, the catalysts are used in the polymerization process carried out in gas-phase. In some embodiments, the gas-phase process is carried out in a fluidized or stirred, fixed bed reactor or in a gas-phase reactor having two interconnected polymerization zones. A first polymerization zone works under fast fluidization conditions. A second polymerization zone provides for the polymer to flow under the action of gravity. In some embodiments, a combination of both type of gas-phase reactors is used. In some embodiments, the catalyst is used to polymerize ethylene in a multistep gas-phase process, wherein a first step is carried out in a fluidized bed gas-phase reactor and a successive step is carried out in a second gas-phase reactor, having two interconnected polymerization zones, wherein a first polymerization zone works under fast fluidization conditions and wherein the polymer flows under the action of gravity in the second polymerization zone.

In some embodiments, the catalysts are used in a polymerization plant set-up not including a pre-polymerization section. In some embodiments, the catalysts are pre-polymerized in a batch scale and then used in liquid or gas-phase olefin polymerization plants, operating without a pre-polymerization line.

In some embodiments and in the main polymerization process, the amount of Al is higher than that used in the pre-polymerization. In some embodiments, the Al-alkyl compound is used in an amount such that the Al/Ti ratio is higher than 20, alternatively between 50 and 800.

In some embodiments, the polymerization is carried out at a temperature of from 20 to 120° ° C., alternatively of from 40 to 90° C.

In some embodiments, the catalyst-forming components (A) and (B) are pre-contacted before the catalyst-forming components are added to the polymerization reactor. In some embodiments, the catalyst-forming components are contacted with a liquid inert hydrocarbon solvent at a temperature below about 60° C., alternatively from about 0° ° C. to 30° C., for a time period of from 10 seconds to 60 minutes. In some embodiments, the liquid inert hydrocarbon solvent is selected from the group consisting of propane, n-hexane, and n-heptane.

In some embodiments, the process is used to prepare polyethylene products. In some embodiments, the polyethylene products are selected from the group consisting of high density ethylene polymers (HDPE, having a density higher than 0.940 g/cm³) made from or containing ethylene homopolymers and copolymers of ethylene with α-olefins having 3-12 carbon atoms; linear low density polyethylenes (LLDPE, having a density lower than 0.940 g/cm³); and very low density polyethylenes and ultra low density polyethylenes (VLDPE and ULDPE, having a density lower than 0.920 g/cm³ to 0.880 g/cm³) made from or containing copolymers of ethylene with one or more α-olefins having from 3 to 12 carbon atoms, having a mole content of units derived from the ethylene higher than 80%.

The following examples are given to illustrate but not limit the present disclosure.

### Characterization

The properties are determined according to the following methods:

### Bulk Density ASTM D 1895/96 Method A

MIE flow index: ASTM-D 1238 condition E
Intrinsic viscosity: determined in tetrahydronaphthalene at 135° C.

5 g of pre-polymerized catalyst were treated under stirring for 30 min. with a mixture made from or containing water (50 ml), acetone (50 ml), and HCl (20 ml), and then filtered. After washings with water and acetone, the residue was dried in an oven under vacuum at 70° C. for 2 hours.

The sample was dissolved in tetrahydronaphthalene at 135° C. and then poured into a capillary viscometer. The viscometer tube (Ubbelohde type) was surrounded by a cylindrical glass jacket; this setup allowed for temperature control with a circulating thermostatic liquid. The passage of the meniscus in front of the upper lamp started the counter which had a quartz crystal oscillator. The counter stopped as the meniscus passed the lower lamp. The efflux time was registered and converted into a value of intrinsic viscosity through Huggins' equation, using the flow time of the pure solvent at the same experimental conditions (same viscometer and same temperature). A single polymer solution was used to determine [η].

### Procedure for the Propylene Polymerization Test

A 4 liter steel autoclave equipped with a stirrer, a pressure gauge, a thermometer, a catalyst feeding system, monomer feeding lines, and a thermostatic jacket, was used. The reactor was charged with 0.01 g of solid catalyst component, 6.6 mmoles of TEAL, 1.6 kg of propylene, and 1.5 NL of hydrogen. The system was heated to 70° ° C. over 10 min. under stirring, and maintained under these conditions for 120 min. At the end of the polymerization, the polymer was recovered by removing any non-reacted monomers and dried under vacuum.

2.5 g of the polymer and 250 ml of o-xylene were placed into a round-bottomed flask, provided with a cooler and a reflux condenser, and kept under nitrogen. The mixture was heated to 135° C. and kept under stirring for about 60 minutes. The final solution was allowed to cool to 0° ° C. under continuous stirring. The insoluble polymer was then filtered at 0° C. The filtrate was then evaporated in a nitrogen flow at 140° C., thereby reaching a constant weight. The content of the xylene-soluble fraction was expressed as a percentage of the original 2.5 grams and then, by difference, the X.I. %.

### Procedure for Gas-Phase Ethylene Polymerization (HDPE)

The polymerization was carried out in a 16.0-liter stainless steel fluidized reactor equipped with a gas-circulation system, a cyclone separator, a thermal exchanger, a temperature and pressure indicator, a feeding line for ethylene, propane, and hydrogen, and a 0.6-liter steel reactor for the catalyst injection of the catalytic system into the fluidized bed reactor.

The composition of the gas phase within the fluidized bed reactor was propane (63 mol %), ethylene (12 mol %), and hydrogen (25 mol %). The reactor reached 24 bar of pressure at 80° C.

Into a 100 mL three-neck glass flask, the following components were introduced in the following order, 20 mL of anhydrous hexane, 0.6 g of TEA, and 0.20 g of the catalyst component. The components were stirred together at room temperature for 5 minutes and then introduced into the 0.6-L reactor with 100 g of propane. The reactor was kept at 30° ° C. for 15 min. before the introduction of the catalytic system into the fluidized bed reactor. The polymerization tests lasted 2 hours at 80° C. After that time, polymerization was stopped, the polymer discharged, dried, and characterized.

### EXAMPLES

### Example 1

### Procedure for the Preparation of the Spherical Support (Adduct of MgCl₂/EtOH)

A magnesium chloride and alcohol adduct was prepared following the method described in Example 2 of U.S. Pat. No. 4,399,054 but working at 2000 RPM instead of 10000 RPM. The resulting adduct was made from or containing about 3 mols of alcohol and about 2.5% wt of H₂O and had an average particle size of about 55 μm. The adduct was subjected to a thermal treatment, under nitrogen stream, over a temperature range of 50-150° C. until a weight content of 25% of alcohol was reached.

### Procedure for the Preparation of the Non-Stereospecific Catalyst Component

Into a 2 L reaction vessel, purged with nitrogen, 1 L of TiCl₄ was introduced at 0° C. Then, at the same temperature, 70 grams of a spherical MgCl₂/EtOH adduct made from or containing 25% wt of ethanol were added under stirring.

The temperature was raised to 130° C. in 2 hours and maintained for 60 min. Then, the stirring was discontinued. The solid product was allowed to settle (in 1 h at 130° C.). The supernatant liquid was siphoned off. A volume of fresh TiCl₄ was introduced into the reactor, thereby providing 1 L of total slurry. The temperature was raised to 130° ° C. under stirring. This temperature was kept for 15 minutes then the stirring was stopped. The solid was allowed to settle (in 1 h at 130° C.). The supernatant liquid was siphoned off.

The solid residue was then washed two times with hexane at 50° C. and three times at 25° C. The solid residue was dried under vacuum at 30° C. and then analyzed.

The spherically-shaped solid had a magnesium content of 19.0% wt, and an average particle size (P50) of 57 micron.

The intermediate solid component was tested in propylene polymerization, using the method described above. The polymer had a xylene insoluble fraction of 48.1% wt.

### Ethylene Pre-Polymerization

Into a 1.5 L glass reactor provided with stirrer, 2 L of hexane at 30° C. and 100 g of the catalyst component were introduced under stirring at 30° C. While maintaining the internal temperature, a mixture of 3.2 g of tri-n-octylaluminum (TnOA) and 0.32 g of cyclohexylmethyldimethoxysilane in i-hexane was slowly introduced into the reactor. After 30 minutes stirring, 110 g of ethylene were introduced into the reactor at the temperature of 50° C. in 2 hours under a constant flow rate. The consumption of ethylene in the reactor was monitored. The monomer feed was discontinued when a theoretical conversion of 1.1 g of polymer per g of catalyst was reached. The reaction was continued for a further 1 h (maturation step), thereby ensuring that the monomer fed was converted. The prepolymer particles were allowed to settle, washed 2 times with hexane at a temperature of 50° C. (60 g/L) and 1 time with hexane at room temperature, and dried under vacuum at 30° C. The pre-polymerized catalysts were analyzed in terms of porosity and average molecular weight (intrinsic viscosity). The data regarding the pre-polymerization conditions and prepolymer characterization are reported in Table 1. The pre-polymerized solid catalyst component was employed in the gas phase ethylene polymerization (HDPE). The results are reported in Table 2.

### Comparative Example C1

The catalyst was prepared according to the procedure described in example 1 but the pre-polymerization process was carried out without the addition of the external electron donor compound. The temperature of the pre-polymerization step was 20° C. TnOA was added in an amount to provide an Al/Ti molar ratio of 0.5. 110 grams of ethylene were fed in a total time of three hours. Catalyst composition and characterization is reported in Table 1. The pre-polymerized solid catalyst component was employed in the gas phase ethylene polymerization. The results are reported in Table 2.

### Example 2

The catalyst was prepared according to the procedure described in example 1 with the difference being that 1.65 grams of cyclohexylmethyldimethoxysilane were introduced into the reactor and that 110 g of ethylene were introduced into the reactor at the temperature of 30° C. in 40 minutes under a constant flow rate. The reactor temperature was 30° C. for pre-polymerization step. Catalyst composition and characterization are reported in Table 1. The pre-polymerized solid catalyst component was employed in the ethylene polymerization according to gas phase procedure. The results are reported in Table 2.

### Example 3

The catalyst was prepared according to the procedure described in example 2 with the difference being that the reactor temperature was 50° ° C. Catalyst composition and characterization are reported in Table 1. The pre-polymerized solid catalyst component was employed in the ethylene polymerization according to gas phase procedure. The results are reported in Table 2.

### Example 4

The catalyst was prepared according to the procedure described in example 2 with the difference being that 0.63 grams of THF were used instead of cyclohexylmethyldimethoxysilane. Catalyst composition and characterization are reported in Table 1. The pre-polymerized solid catalyst component was employed in the ethylene polymerization according to gas phase procedure. The results are reported in Table 2.

### Example 5

The catalyst was prepared according to the procedure described in example 2 with the difference being that 3.9 grams dioctyl sulfosuccinate sodium salt (DOSS) were used instead of cyclohexylmethyldimethoxysilane. Catalyst composition and characterization are reported in Table 1. The pre-polymerized solid catalyst component was employed in the ethylene polymerization according gas phase procedure. The results are reported in Table 2.

### Example 6

The catalyst was prepared according to the procedure described in example 2 with the difference being that no external donor was used. Catalyst composition and characterization are reported in Table 1. The pre-polymerized solid catalyst component was employed in the ethylene polymerization according to gas phase procedure. The results are reported in Table 2.

### Example 7

The catalyst was prepared according to the procedure described in example 2 with the difference being that 110 g of ethylene were introduced into the reactor at the temperature of 30° C. in 360 minutes under a constant flow rate. The reactor temperature was 30° C. for pre-polymerization step. Catalyst composition and characterization are reported in Table 1. The pre-polymerized solid catalyst component was employed in the ethylene polymerization according to gas phase procedure. The results are reported in Table 2.

TABLE 1
Pre-polymerization conditions and characterization.

| | Pre-polymerization Conditions | | | | Prepolymer characterization | | | | |
|---|---|---|---|---|---|---|---|---|---|
| Cat. | Al/(Donor | Al/ | T | Time | PE/cat | IV | Porosity | APR | BD |
| Ex. | (mol) | Ti | ° C. | hr | g/g | dL/g | cm³/g | (nm) | g/cm³ |
| 1 | 5.0 | 0.1 | 50 | 2 | 1.1 | 6.06 | 0.43 | 170 | 0.468 |
| 2 | 1.0 | 0.1 | 30 | 0.67 | 1.05 | 8.0 | 0.60 | 208 | 0.392 |
| 3 | 1.0 | 0.1 | 50 | 0.67 | 1.04 | 6.0 | 0.53 | 240 | 0.37 |
| 4 | 1 | 0.1 | 30 | 0.67 | 1.04 | 11.2 | 0.372 | 155 | 0.4 |
| 5 | 1 | 0.1 | 30 | 0.67 | 0.99 | 7.9 | 0.763 | 254 | 0.35 |
| C1 | — | 0.5 | 20 | 3 | 1.1 | 1.9 | 0.70 | 310 | 0.32 |
| 6 | — | 0.1 | 30 | 0.67 | 1.06 | 10.8 | 0.382 | 155 | 0.46 |
| 7 | 1 | 0.1 | 30 | 3 | 1.05 | 8.0 | 0.70 | 350 | 0.390 |

TABLE 2
Gas phase polymerization HDPE

| Cat. | Mil. | MIE | BDP | <500 μm | <300 μm |
|---|---|---|---|---|---|
| Example | kg/g | (g/10′) | (g/cc) | % | % |
| 1 | 1.84 | 51.8 | 0.344 | 6.5 | 1.9 |
| 2 | 1.8 | 75.5 | 0.346 | 2.1 | 0.5 |
| 3 | 2.04 | 105 | 0.322 | 3 | 0.9 |
| 4 | 1.6 | 102 | 0.334 | 7.1 | 2.2 |
| 5 | 1.7 | 141 | 0.31 | 4.1 | 0.9 |
| C1 | 1.6 | 79 | 0.302 | 21.2 | 9.0 |
| 6 | 1.4 | 61 | 0.302 | 15 | 5 |
| 7 | 1.9 | 90 | 0.328 | 2.8 | 0.8 |

1. A pre-polymerized catalyst component for the polymerization of olefins comprising:
(a) a solid catalyst component; comprising Ti, Mg, and a halogen and optionally, a bidentate electron donor compound (BE) in an amount such that the molar ratio (BE)/Ti ranges from 0 to 0.3, and
(b) an ethylene (co)polymer in an amount ranging from 0.1 g up to less than 30 g per g of the solid catalyst component, and having an intrinsic viscosity, measured in tetraline at 135° C., of at least 3.0 dL/g;
wherein the pre-polymerized catalyst component has a porosity measured by mercury method in the range 0.1 to 1.0 cm³/g.

2. The pre-polymerized catalyst component according to claim 1, wherein the intrinsic viscosity is equal to or higher than 4.0 dl/g.

3. The pre-polymerized catalyst component according to claim 2, wherein the intrinsic viscosity ranges from 4.5 to 15 dl/g.

4. The pre-polymerized catalyst component according to claim 1, wherein the ethylene (co)polymer is an ethylene homopolymer or an ethylene copolymer containing less than 5% mol of an alpha-olefin having the formula CH₂═CHR¹, wherein R¹ is a C₁-C₆ linear alkyl group.

5. The pre-polymerized catalyst component according to claim 1, wherein the ethylene (co)polymer is an ethylene homopolymer.

6. The pre-polymerized catalyst component according to claim 1, wherein the mercury porosity due to pores up to 1 μm ranges from 0.2 to 0.9 cm³/g.

7. The pre-polymerized catalyst component according to claim 1, having a bulk density ranging from 0.34 to 0.50 g/cm³.

8. The pre-polymerized catalyst component according to claim 1, wherein the amount of alpha-olefin (co)polymer is from 0.5 to 2.5 g per g of solid catalyst component.

9. The pre-polymerized catalyst component according to claim 1, wherein the magnesium derives from magnesium dichloride and the titanium atoms derive from titanium compounds of formula Ti(OR^{II})_{4-y} X_{y}, wherein R^{II} is a C₁-C₂₀ hydrocarbon group, X is halogen, and y is a number between 1 and 4.

10. The pre-polymerized catalyst component according to claim 1, wherein the solid catalyst component further comprises a monodentate (MD) electron donor compound selected from the group consisting of esters of aliphatic or aromatic carboxylic acids and cyclic alkyl ethers.

11. The pre-polymerized catalyst component according to claim 10, wherein the monodentate electron donor compound is present in an amount such that the (MD):Ti ratio ranges from 0.1:1 to 25:1.

12. A process for the preparation of a pre-polymerized catalyst component comprising
pre-polymerizing
(a) a solid catalyst component (a) comprising Ti, Mg, and a halogen and optionally, a bidentate electron donor compound (BE) in an amount such that the molar ratio (BE)/Ti ranges from 0 to 0.3, with
(b) ethylene and optionally an alpha olefin CH₂—CHR¹ such that the amount of ethylene (co)polymer generated ranges from 0.1 up to 50 g per g of the solid catalyst component,
wherein the pre-polymerization is carried out at a temperature ranging from 25 to 100° C. in the presence of (B) an Al alkyl compound such that the molar ratio Al/Ti is lower than 0.5.

13. A catalyst system for the polymerization of olefins comprising the product obtained by contacting (A) a pre-polymerized catalyst component according to claim 1 with (B) an Al-alkyl compound.

14. (canceled)

15. (canceled)
